(19) United States
(12) Patent Application Publication
(10) Pub. No.: US 2013/0200089 A1
(43) Pub. Date: Aug. 8, 2013

(54) Weighted Portable Beverage Container Support

(71) Applicants: Wil Vidal, Pewaukee, WI (US); Mary Vidal, Pewaukee, WI (US)

(72) Inventors: Wil Vidal, Pewaukee, WI (US); Mary Vidal, Pewaukee, WI (US)

(21) Appl. No.: 13/367,542

(22) Filed: Feb. 7, 2012

(51) Int. Cl. B65D 25/00; B23P 11/00

(52) U.S. Cl. 220/739; 29/428

(57) ABSTRACT

A beverage container support assembly having an engagement device that removably cooperates with a beverage container and a counterweight secured to the engagement device. The engagement device is constructed of a flexible material and encloses a plurality of particles to allow the flexible material to contour to an underlying surface while maintaining a substantially upright orientation of a beverage container engaged with the engagement device.

### BACKGROUND OF THE INVENTION

The present invention relates to a support for beverage containers and more particularly, to a beverage container support that preferably includes an engagement device configured to removably cooperate with a beverage container, such as a beverage can or bottle, and a flexible support that contours to the shape of a supporting surface and increases the footprint associated with maintaining an upright orientation of the beverage container.

Many people are familiar with the convenience and portability associated with beverage containers such as cans and bottles. Such beverage containers are commonly configured to contain 10-24 ounces, and most commonly 12 ounces, of a particular beverage. Such beverage containers are commonly provided in cylindrical shapes which contain liquids intended to be consumed while chilled. Normally, such beverages are served upon removal from a refrigerator or ice chest. If consumption is rapid enough, the liquid is consumed while still at least somewhat chilled but in high temperature environments, such as when the container is subjected to direct sunlight, the temperature of the fluid may rise faster than a given consumer desires to consume the beverage contained therein. Such scenarios have resulted in the prolific acceptance of beverage insulators, colloquially termed “can koozies” or insulators which insulate the beverage container during consumption of the beverage. Such insulators are commonly provided in various shapes and sizes that are commonly determined as a function of the size and shape of the beverage container.

Although such insulators provide a convenient device for reducing thermal exchange between the beverage and an environment, such devices are not without their respective drawbacks. In its simplest form, such beverage insulators only marginally increase the footprint of a respective beverage container. Such insulators are also commonly formed of a somewhat pliable foam material. The nominal increase in the size of the footprint of the beverage container and the pliable nature of the insulator does little or negligibly contributes to maintaining a desired vertical orientation of the beverage container when the insulated container is set down. The pliable nature of the insulator and the extension of the insulator in the vertical direction along the body of the container do little to improve the unintended tipping of the beverage. When set down, such insulated beverage containers must commonly be supported in the same manner as the beverage container via a generally flat horizontal surface to prevent undesired tipping of the insulator and beverage container and do little to maintain the desired upright orientation of the beverage container.

Others, having recognized this shortcoming of conventional beverage insulators, have provided beverage insulators that are constructed for use in specific environments or constructed to cooperate with such convention tube shaped beverage insulators. Such systems, such as those disclosed in U.S. Patent Application Publication Nos. 2010/0301053, 2006/0091141, and 2004/0040968 include an insulator that is associated with a counterweight that is positioned at the bottom of the insulator and intended to maintain an upright orientation of the beverage container and insulator when the insulated beverage container is placed in water, such as a pool or a lake. Such assemblies do little to improve or completely negate the vertical compliance of the beverage container and insulator when the same are not used in a water environment. Still others, such as U.S. Patent Application Publication No. 2011/0114656 improve the vertical compliance of the beverage container and insulator by increasing the footprint of the insulator and providing a suction interface between the insulator and the underlying support surface. Unfortunately, such a configuration also increase the area of the flat surface necessary for adequately supporting the insulated beverage container and limits use of the beverage container support for other applications.

Still others, such as U.S. Pat. No. 6,941,601, disclose a beverage container insulator that is in the form of a pillow having a cavity for receiving a beverage container formed therein. Although the pillow increases the footprint associated with the beverage, those skilled in the art will readily appreciate that such a configuration is susceptible to tipping and/or spilling of the associated beverage during movement of others on the furniture and is ill-suited for outdoor uses.

As evidenced by the various references above, it is appreciated that such beverage insulators are commonly used in a plethora of environments. Whether used in a water environment or more static environment such as tailgating or camping, such devices commonly require a generally flat and lever support surface to maintain the desired vertical orientation of the beverage. However, it is appreciated that the use of such beverage support systems are not limited to static or non-moving environments. For example, such devices are commonly used in boating activities. Recognizing the preference of having beverages at the ready in the marine environment, many marine product manufactures provide beverage supports that are constructed to cooperate with the beverage and/or the insulated beverage container in a manner that restricts movement of the beverage container during the pitch and roll associated with operation of such watercraft. Whether in the shape of a cup holder recess or a gimbal ring beverage cage, such methodologies are not uniformly applied or applicable across marine devices.

Commonly, a watercraft can be rated to support more passengers than available beverage supports leaving those without such a dedicated support to hold their beverage, ask another passenger to do the same, or wedge the beverage between their limbs or flexible structures of the watercraft to free the passenger's hands. A classic or collectible marine vessel is one environment where the absence of adequate beverage supports can be readily observed. Such vessels commonly have wooden hulls and decking wherein the beauty and esthetics of the vessel negates the use of many after-market beverage container supports and/or beverage container insulators. Starting and operation of such vessels also commonly requires both of an operator's hands to effectuate the desired activity. For instance, starting of a classic boat often requires concurrent manipulation of an engine choke, manual neutralling of a transmission or drive train, operation of of an ignition key, manipulation of a throttle, and/or manipulation of a steering wheel. Commonly, the beverage of the operator, whether insulated or not, is precariously “balanced” nearby with the hope that the same will not be lost.

Accordingly, there is a need for a beverage container support that can removably cooperate with the shape of one or more beverage containers, insulates a respective beverage, does not interfere with or otherwise risk damage of the underlying support surface, and can maintain a generally upright orientation of the beverage container independent of the shape and contour of the supporting surface.

### BRIEF DESCRIPTION OF THE INVENTION

The present invention provides a beverage supporting system that overcomes one or more of the aforementioned drawbacks. One aspect of the invention discloses a beverage container support assembly having an engagement device that removably cooperates with a beverage container and a counterweight that is secured to the engagement device. The engagement device is constructed of a flexible material and encloses a plurality of particles to allow the flexible material to contour to an underlying surface while maintaining a substantially upright orientation of a beverage container engaged with the engagement device. Such a configuration allows the beverage container support assembly to support the beverage container in an upright orientation and cooperate with non-planar surfaces.

Another aspect of the invention that is useable with one or more of the above aspects discloses a beverage support having a jacket that is formed of an insulating material and shaped to removably cooperate with a beverage container. The jacket includes an open end that is configured to receive a beverage container and a support end opposite the open end. A counterweight is secured to the support end of the jacket and includes a flexible shell and a plurality of particles that are contained in the shell. A number of and preferably most or all of the plurality of particles are moveable relative to one another and the shell to allow the shell to contour to the shape of a surface onto which the beverage support is placed.

Another aspect of the invention that is useable with one or more of the above aspects discloses a beverage container counterweight assembly that includes an interface configured to removably cooperate with a beverage container. A flexible container is secured to the interface and extends beyond a vertical footprint of the interface. A plurality of particles are enclosed by the container and at least a portion of the plurality of particles are moveable relative to each other and the container to allow the container to contour to a shape of an underlying structure associated with supporting the beverage container associated with the counterweight assembly.

Another aspect of the invention that is useable with one or more of the above aspects discloses a method of forming a beverage container support assembly. The method includes forming an engagement device that is shaped to cooperate with a beverage container. A flexible container that has a vertical footprint that is larger than a footprint of the engagement device is secured to the engagement device. A plurality of particles are enclosed in the container so that the flexible container can contour to an underlying support surface.

In a preferred aspect, the beverage support or counterweight assembly is formed of water resistant or water proof materials. In another preferred aspect one or more of the beverage container insulator, particle container or counterweight are formed in a theme and/or a theme specific to a given environment, event, or time of year. In another preferred aspect, the particles are formed of a magnetic material.

These and other aspects and features of the invention summarized above are not limited to any one particular embodiment of the invention. That is, many or all of the aspects above may be achieved with any particular embodiment of the invention. Those skilled in the art will appreciate that the invention may be embodied in a manner preferential to one aspect or group of aspects and advantages as taught herein. These and various other aspects, features, and advantages of the present invention will be made apparent from the following detailed description and the drawings.

### BRIEF DESCRIPTION OF THE DRAWINGS

The drawings illustrate preferred embodiments presently contemplated for carrying out the invention.

FIG. 1 is a perspective side view of a beverage container support according to one embodiment of the present invention;

FIG. 2 is a view similar to FIG. 1 and shows a partial cross-sectional view of a beverage container support according to another embodiment of the present invention;

FIG. 3 is a view similar to FIG. 1 and shows a beverage container support according to another embodiment of the invention; and

FIG. 4 is a perspective view of a number of the beverage container supports shown in FIG. 1 in an exemplary marine environment.

In describing the preferred embodiments of the invention which are illustrated in the drawings, specific terminology is resorted to for the sake of clarity. However, it is not intended that the invention be limited to the specific terms so selected and it is to be understood that each specific term includes all technical equivalents which operate in a similar manner to accomplish a similar purpose. For example, the word connected or terms similar thereto are often used. Such terms are not limited to direct connection but include connection through other elements where such connection is recognized as being equivalent by those skilled in the art.

### DETAILED DESCRIPTION OF THE PREFERRED EMBODIMENT

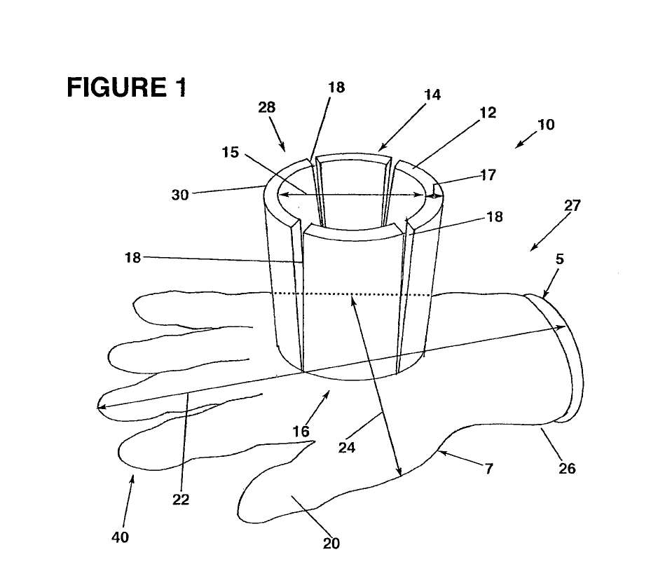

FIG. 1 shows a beverage container support assembly, beverage container counterweight assembly, a beverage support, or beverage support assembly 10 according to one embodiment of the present invention. Support assembly 10 includes engagement device, flexible container, or jacket 12 that is shaped to removably cooperate with a beverage container, such as a can, a glass or plastic bottle, a water bottle, or other fluid container device such as a wine glass, a child's spill proof or “sippy” cup, etc. As shown, jacket 12 is shaped to slidably cooperate with 8, 12, and/or 16 ounce can or bottle beverage container although it is envisioned beverage support assembly 10 could be configured to cooperate with beverage containers having different shapes.

Preferably, jacket 12 is formed of an insulative material, such as an open or closed cell foam, plastic, or rubber-like material. Jacket 12 includes an open end 14 that is shaped to slidably receive a beverage container as described above. Preferably, jacket 12 is formed of a flexible foam-like material that is sufficiently elastic to accommodate various different sized beverage containers. Preferably, jacket 12 can be provided in an adjustable or stretchable configuration or various alternate form factors designed to hold most commonly accepted beverage containers loosely, but snug enough, so the beverage can be conveniently placed in and removed from jacket 12 quickly and easily with one hand and still be protected against undesired movement.

Alternatively, if jacket 12 is constructed to cooperate with a wine glass shaped beverage container, jacket 12 could be shaped as a clip configured to slidably cooperate with only the base of such a vessel as compared to slidably engaging the longitudinal length of a beverage container such as a more conventional 12 or 16 fluid ounce can, cup, or bottle shapes. Open end 14 of jacket 12 has a diameter, indicated by arrow 15, that allows jacket 12 to snuggly engage a beverage container disposed therein so as to reduce thermal exchange between the beverage container and atmosphere. As used herein, the snug engagement between the beverage container and the jacket should be understood as a slidable interaction between the beverage container and the jacket that requires user interaction to insert and remove the container from the jacket. In one embodiment, the interior diameter 15 of jacket 12 is approximately 3.25 inches in diameter.

Preferably, jacket 12 has a thickness, indicated by arrow 17, that is sufficient to allow a beverage container to maintain a desired or tolerable beverage temperature to allow full consumption of the respective beverage with a tolerable or negligible temperature change from start to finish of the beverage. Understandably, thickness 17 of jacket 12 can vary as a function of the material of jacket 12, the insulative and/or the elasticity of the material, and/or preferences of the user of support assembly 10 with respect to the exterior gripping diameter of jacket 12, interior diameter 15, and the shape of a beverage container intended to be used therewith, etc. It is appreciated that the thermal exchange between the beverage container and the atmosphere will be largely dependent on the difference between the desired temperature of the beverage and ambient or environment temperature. In one embodiment, thickness 17 is approximately 0.25 inch and can be uniform or dissimilar along the longitudinal length of jacket 12.

Jacket 12 includes a support end 16 that is generally opposite open end 14 and which cooperates with a counterweight or flexible container 20 that is preferably permanently affixed to jacket 12. Jacket 12 includes one or more vents or slots 18 that facilitate the convenient removal of a beverage container from jacket 12 and prevent or reduce a vacuum seal which could hinder the removal of an empty or otherwise undesired beverage container from jacket 12. In addition to reducing the pressures that may interfere with cooperation of a beverage container with jacket 12, when provided as elongated slits, slots 18 allow jacket 12 to accommodate coffee cups or mugs wherein the handle passes through a respective slot of jacket 12.

Although shown as a number of slots, it is appreciated that the vent could be formed as an opening or a perforated or breathable sheet material and disposed through other portions of jacket 12 such as being formed in a bottom portion of jacket. It is appreciated that such a vent can be formed by extending radially through jacket 12 or in a downward direction through flexible container 20 such that the volume defined by jacket 12 is exposed to atmosphere both at open end 14 and a vent positioned nearer the opposite longitudinal end of jacket 12. It is further appreciated that the volume defined by jacket 12 could also be provided as extending into the volume bounded by container 20. Such a configuration would act to lower the center of gravity associated with the beverage container relative to container 20 and thereby improve to stability of assembly 10 and a beverage container associated therewith.

Regardless of the specific construction, support end 16 of jacket 12 abuts, cooperates, or is otherwise secured to flexible container 20. Preferably, jacket 12 is permanently affixed to container 20 but it is envisioned that jacket 12 could be removable and/or configured to interchangeably cooperate with container. Container 20 defines a longitudinal length, indicated by line 22, and a lateral width, indicated by line 24, to define a horizontally oriented footprint 27 that is defined by a perimeter 26 of container 20. In one preferred aspect, container 20 provided in a glove shape measures approximately 10 inches in length and approximately 4.75 wide where the little finger meets the base and extending where the thumb meets the base of the glove hand when oriented at rest such that the glove or hand shape of container 20 provides a suitably sized area to support a beverage placed in assembly 10 in a stable fashion. Regardless of the specific dimensions, jacket 12 defines a horizontally oriented footprint 28 defined by a horizontal cross-sectional area, that is associated with a perimeter 30 of jacket 12. Footprint 28 of jacket 12 is preferably wholly contained within footprint 27, or horizontal cross-section, of container 20 preferably regardless of the instantaneous shape of container 20.

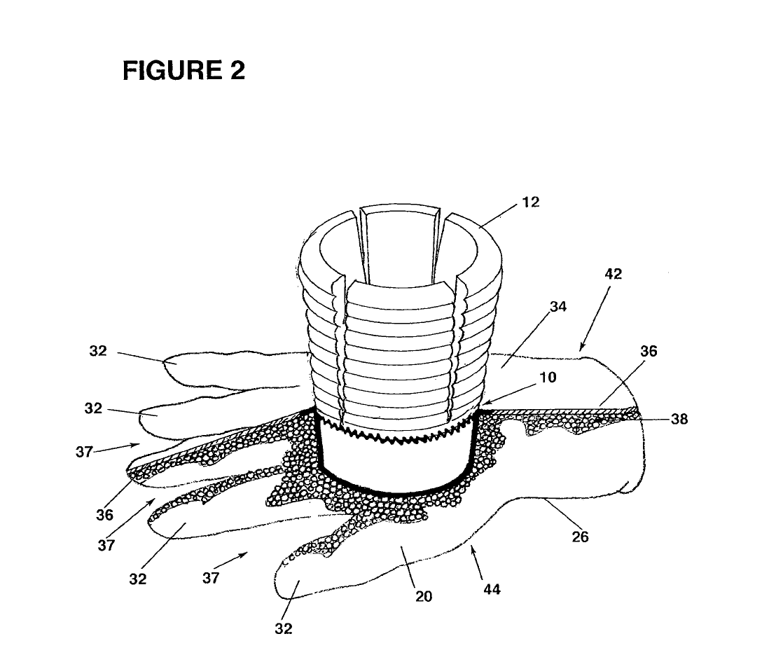

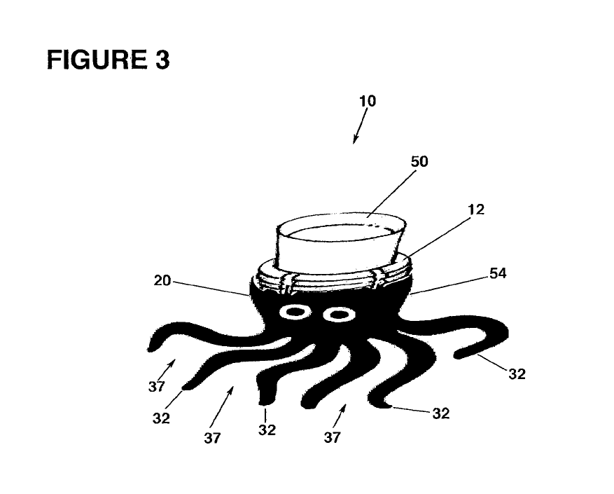

Like jacket 12, it is envisioned that container 20 could be provided in any number of form factors. Referring to FIGS. 1 and 2, it is envisioned that jacket 12 be provided in any number of shapes, such as a more conventional shape of a generally planar walled cylinder shape as shown in FIG. 1, or more unique or stylized shapes such as a monkeys first, a turban knot, a Turk's head, marine related things such as a life jacket or other personal floatation device or as an anchor of fishing device related shape, as a person (real or fictional), an animal (real or fictional), as an anatomical feature, and/or, such as a rope spool, as shown in FIG. 2, or in any number of other shapes. As shown in FIGS. 2 and 3, it is likewise appreciated that the shape of container 20 could also be provided in any number of form factors, such as a hand, as shown in FIGS. 1 and 2, or as a real or mythical creature, such as the tentacles of a squid, kraken, or octopus as shown in FIG. 3, or other anatomic features, real or fictional creatures or characters, be event specific such as spider web or the hand of a mummy, zombie, or Dracula if used during Halloween, a flexible wreath shape or hand of Santa Claus or a Grinch or other character if used during Christmas, or other holiday or event specific configurations and/or shapes. Irrespective of the actual shape, the present invention provides a beverage support assembly 10 that is not cumbersome but is entertaining as well as provides a convenient and user friendly beverage support assembly.

It is further appreciated that jacket 12 and container 20 can have a combined shape that cooperate with one another to define a particular structure, person, recognizable element, or holiday or event specific element or theme. For instance, jacket 12 could be shaped to mimic a Christmas tree whereas container 20 would be shaped as a stand associated with supported the tree shaped jacket. Regardless of the specific configuration of jacket 12, container 20, and/or the combination thereof, container 20 is constructed to be pliable and deformable so as to at least partly contour to the shape of the structure disposed under assembly 10 to maintain a generally upright orientation of the beverage container associated with jacket 12 even when used on uneven and/or moving support surfaces—such as are common in marine environments.

As shown in FIG. 2, in one embodiment, container 20 is glove or hand shaped such that container 20 includes a number of arms, legs, fingers, lobes, or projections 32 that extend in one or more outward radial directions from a body or palm portion 34 of container 20 of assembly 10. Preferably, a space 37 is formed between adjacent projections 32 such that each projection 32 can move independent relative to the other projections 32 and with relative to palm portion 34. Such a construction allows the shape of container 20 to contour to an underlying surface. Preferably, a support structure facing surface or downward facing surface 40 of container 20 is formed of non-skid and/or non-scratching material so as to help maintain a desired orientation of the assembly 10 once placed on a surface and so as to not mar or otherwise blemish the surface onto which the assembly 10 is placed. Preferably, at least a portion of surface 40 of assembly 10 includes a surface that has a higher coefficient of friction than the structure onto which assembly 10 is placed.

Still referring to FIG. 2, container 20 includes a shell 36 that encloses a plurality of particles 38 therein. Particles 38 are preferably movable relative to one another and shell 36 such the flexible container 20 can be contoured to generally match the contour of an underlying surface to maintain jacket 12 and a beverage associated there with a generally upright vertical orientation. When placed on a generally planar flat surface, container 20 assumes the position generally shown in FIG. 2. When placed on an edge, corner, or other generally non-planar surface, projections 32 and a wrist portion 42 of container 20, and the particles 38 associated therewith, deflect or deform relative to a palm portion 44 of container 20 such that container 20 wraps around such non-planar structures thereby maintaining jacket 12, and a beverage container associated therewith, in a generally upright vertical orientation relative thereto.

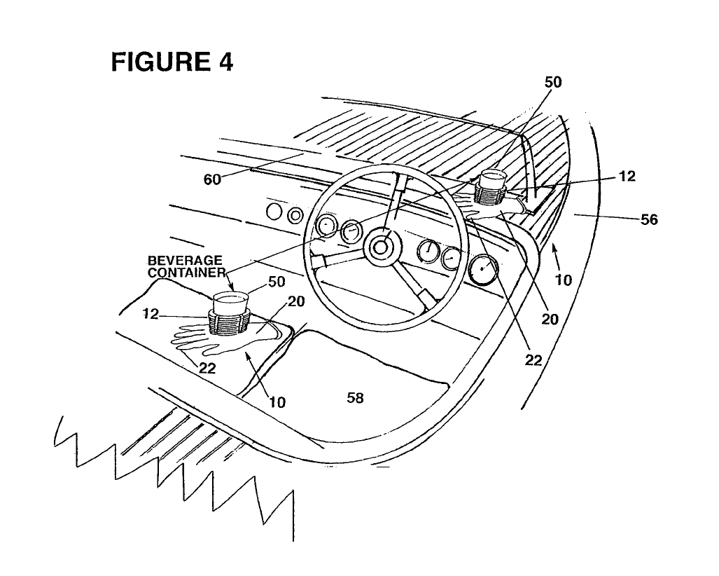

As discussed further below with respect to FIG. 4, it is envisioned that assembly 10 would be usable in marine or other near or in water environments and/or be periodically exposed to inclement weather conditions. As such, it is further envisioned that one or more of jacket 12, container 20, and particles 38 have a water resistant or waterproof construction. For example, it is envisioned that container 20 could be formed of a waterproof fabric or similar material and have any necessary closures formed with weather or waterproof thread or the like.

It is envisioned that particles 38 preferably be provided as any particle material that is not reactive or otherwise degrades when subjected to water or moisture and/or adverse weather conditions so as to maintain a flexible or moveable inter-particle association across a wide variety of ambient or use conditions. It is envisioned that particles 38 associated with container 20 can be toy box sand, small or micro sized pebbles or BB's, and/or magnetically active materials. Alternatively, it is envisioned that container 20 be filled with other particle materials such as popcorn seeds, dried beans, rice or other small grains, and/or combinations thereof. Regardless of the specific composition of particles 38, the movable relationship of the particles between each other and the container allows assembly 10 to be pliable such that container 20 can contour of many structures commonly available where people gather, in or on watercraft, in or on other road and off road vehicles, and/or at virtually any indoor and/or outdoor settings. Preferably, particles 38 have a collective weight that lends stability or acts as a counterweight so as to maintain an upright orientation of a particular beverage container associated therewith.

It is further appreciated that were container 20 filled with a magnetic material and/or to include at least one magnetic particle, such a configuration would provide a unique responsiveness of container 20 to contour and maintain a given shape and/or to cooperate with metal or magnetic underlying materials or structures to which container 20 is associated. It should be appreciated that such a configuration would provide assembly 10 with an apparent “clinging” or “sticking” ability when positioned proximate a metal or magnetic surface. Regardless of the specific configuration or composition of particles 38, it is further appreciated that, in addition to be useable to maintain the upright oriented of a particular beverage container, it is further appreciated the weighted nature of container 20 and the particles 38 associated therewith provides a weighted holding like a paperweight for materials, such as papers or napkins, that can be disposed between container 20 and the underlying surface.

Although shown in FIG. 2 with the hand shaped container 20 oriented in a generally downward facing direction and jacket 12 oriented in an upward facing direction, it is further appreciated that assembly 10 could be formed by a pair of hand shapes wherein a first hand faces in a generally upward direction whereas a second hand faces in a generally downward facing direction such that the back of each respective hand is connected to each other and such that the “fingers” defined by the corresponding projections extend in opposite directions.

FIG. 3 shows assembly 10 in a marine based theme of an octopus. As shown in FIG. 3, jacket 12 and container 20 cooperate with one another to establish the shape of an octopus. A beverage container 50, such as a cup, that contains a beverage 52 is slidably disposed in jacket 12. Projections 32 of container 20 depend in a generally downward direction relative to the opening of beverage container 50 and are shaped to flexibly cooperate with an underlying supporting structure. Container 20 and/or a sidewall of jacket 12 can include graphics or other signage or continue the theme in providing supplemental structure, such as a pair of eyes 54 to provide a more complete representation of the underlying real or imaginary character or animal formed by jacket 12 and container 20. Understandably, the octopus shown in FIG. 3 is merely exemplary of one themed structure or form factor of the present invention.

FIG. 4 shows a pair of beverage support assemblies 10 according to the present invention in the exemplary environment of a watercraft 56. A beverage container 50 is engaged with the jacket 12 of each assembly 10. Each jacket 12 is shown in a nautical motif as a rope knot or coil. Particle container 20 is shown as having a glove or hand shape but could be shaped so as to define tentacles, as shown in FIG. 3, or to have other shapes as disclosed above. The projections 22 associated with each particle container 20 are shaped to allow the respective particle container 20 to conform to the shape of the underlying structure, be it a vessel seat or seat cushion 58, a dashboard 60, or other structures of the underlying vehicle or other surrounding environment. For use with a vintage watercraft wherein beverage holders are not preformed and/or the aesthetics of the underlying vehicle do not lend themselves to modification and/or permanent mounting of beverage cages or hangers, assemblies 10 provide a convenient means to support a beverage in a non-marring and temporary manner and in a manner that can be utilized to prevent loss of other materials, such as papers and/or napkins that can be simply placed under the assembly 10.

Regardless of the environment and/or the motif, assembly 10 provides an extra hand or multiple extra hands for supporting refreshments in environments that do not lend themselves to other know beverage container support systems. Additionally, when used in a marine or other environment that involves a moving underlying vehicle or structure, the counterweighted nature and the ability to contour the shape of the beverage support assembly 10 to the underlying structure provides a beverage support system that acts as a supplemental deckhand with respect to freeing the hands of passengers for other recreational and/or operational activities.

Therefore, one embodiment of the invention includes a beverage container support assembly having an engagement device that removably cooperates with a beverage container and a counterweight that is secured to the engagement device. The engagement device is constructed of a flexible material and encloses a plurality of particles to allow the flexible material to contour to an underlying surface while maintaining a substantially upright orientation of a beverage container engaged with the engagement device. Such a configuration allows the beverage container support assembly to support the beverage container in an upright orientation and cooperate with non-planar surfaces.

Another embodiment of the invention that is useable with one or more of the features of the above embodiment includes a beverage support having a jacket that is formed of an insulating material and shaped to removably cooperate with a beverage container, such as a can or a bottle. The jacket includes an open end that is configured to receive the beverage container and a support end opposite the open end. A counterweight is secured to the support end of the jacket and includes a flexible shell and a plurality of particles that are contained in the shell. The plurality of particles are moveable relative to one another and the shell to allow the shell to contour to the shape of a surface onto which the beverage support is placed.

Another embodiment of the invention that is usable with one or more of the features of the above embodiments includes a beverage container counterweight assembly having an interface configured to removably cooperate with a beverage container. A flexible container is secured to the interface and extends beyond a vertical footprint of the interface. A plurality of particles are enclosed by the container and at least a portion of the plurality of particles are moveable relative to each other and the container to allow the container to contour to a shape of an underlying structure associated with supporting the beverage container associated with the counterweight assembly.

Another embodiment of the invention that is useable with one or more of the features of the above embodiments includes a method of forming a beverage container support assembly. The method includes forming an engagement device that is shaped to cooperate with a beverage container. A flexible container that has a vertical footprint that is larger than a footprint of the engagement device is secured to the engagement device. A plurality of particles are enclosed in the container so that the flexible container can contour to an underlying support surface.

The present invention has been described in terms of the preferred embodiments, and it is recognized that equivalents, alternatives, and modifications, aside from those expressly stated, are possible and within the scope of the appending claims.

1. A beverage support comprising:
a jacket formed of an insulating material and shaped to removably cooperate with a beverage container, the jacket having an open end configured to receive a beverage container and a support end opposite the open end; and
a counterweight secured to the support end of the jacket, the counterweight including a shell that is flexible and a plurality of particles that are contained in the shell, the plurality of particles being moveable relative to one another and the shell; and
wherein the shell is defined by a body portion and a plurality of projections that extend in outward radial directions relative to the body portion such that a space is formed between adjacent projections and each projection is independently movable in a plurality of directions relative to other projections for conforming to non-planar support surfaces.

2. The support of claim 1 wherein the jacket is shaped to slidably cooperate with a cylindrical beverage container.

3. The support of claim 1 wherein the shell is shaped like a glove.

4. The support of claim 1 wherein the shell has a theme shape.

5. The support of claim 1 wherein the plurality of particles are waterproof.

6. The support of claim 1 wherein the plurality of particles are further defined as at least one of sand, pebbles, a shot material, coffee beans, popcorn kernels, a magnetic material.

7. The support of claim 1 wherein the shell is formed of a material having a coefficient of friction that is greater than a coefficient of friction of a surface upon which the shell is placed.

8. A beverage container counterweight assembly comprising:
an interface configured to removably cooperate with a beverage container;
a flexible container secured to the interface and extending beyond a vertical footprint of the interface, the flexible container being defined by a body portion and a plurality of lobe portions wherein adjacent lobe portions are separated by a space so that each of the plurality of lobes is independently movable in opposite lateral directions and opposite vertical directions relative to others of the plurality of lobe portions to conform to a shape of an underlying structure; and
a plurality of particles enclosed by the container, at least a portion of the plurality of particles being moveable relative to each other and the container to allow the container to contour to the shape of the underlying structure.

9. The assembly of claim 8 wherein at least one of the interface, the container, and the plurality of flexible particles are waterproof.

10. (canceled)

11. The assembly of claim 8 wherein the body portion and the plurality of lobe portions are oriented to mimic a recognizable element.

12. The assembly of claim 11 wherein the recognizable element is a hand, an octopus, a fish, a character, a holiday specific element.

13. The assembly of claim 8 wherein the interface is shaped as at least one of an upward directed cupped hand, a monkey's fist, a turks head, and shaped to removably receive at least one of a beverage can, a beverage cup, a wine glass, and a sippy cup.

14. The assembly of claim 8 wherein the interface is formed from at least one of an insulating material and a waterproof material.

15. The assembly of claim 8 wherein at least a side of the container that faces away from the interface is formed of material having a coefficient of friction that is higher than a coefficient of friction associated with the underlying structure.

16. A method of forming a beverage container support assembly comprising:
forming an engagement device shaped to cooperate with a beverage container; and
securing a flexible container that has a vertical footprint that is larger than a footprint of the engagement device to the engagement device;
shaping the flexible container to include a body portion that generally underlies the engagement device and a plurality of projections that extend in outward radial directions from the body portion and are each independently movable in at least three directions relative to the body portion; and
enclosing a plurality of particles in the container and separating adjacent ejections with a space so that the flexible container and the plurality of projections can contour to an underlying support surface.

17. The method of claim 16 further comprising further comprising forming at least one of the engagement device, the container, and the plurality of particles from a waterproof material.

18. The method of claim 16 further comprising forming at least one of the flexible container and the engagement device in the shape of at least one of a monkey's fist, a turban knot, turk's head, a person, an animal, and an anatomic feature.

19. The method of claim 16 further comprising forming the engagement device to removably cooperate with at least one of a beverage can, a wine glass, and a sippy cup.

20. The method of claim 16 further comprising forming the engagement device of an insulative material that is shaped to slidably cooperated with a beverage can and includes a vent structure that facilitates removal of the beverage can from the engagement device.
